(19) United States
(12) Patent Application Publication
(10) Pub. No.: US 2021/0080104 A1
(43) Pub. Date: Mar. 18, 2021

(54) AIR PREHEATER AND METHOD OF DECOMPOSING AND REMOVING AMMONIUM BISULFATE FROM A REGENERATIVE HEATING ELEMENT OF THAT AIR PREHEATER

(71) Applicant: University of Kentucky Research Foundation, Lexington, KY (US)

(72) Inventors: Kunlei Liu, Lexington, KY (US); Heather Nikolic, Lexington, KY (US); Chenggua Ma, Suangyashan City (CN)

(21) Appl. No.: 17/014,164

(22) Filed: Sep. 8, 2020

Related U.S. Application Data
(60) Provisional application No. 62/896,621, filed on Sep. 6, 2019.

(51) Int. Cl. F23L 15/02; F28G 11/00; F23L 99/00

(52) U.S. Cl. CPC F23L 15/02; F23L 99/00; F28G 11/00

(57) ABSTRACT

An air preheater for a solid fuel-fired power plant includes a housing, a regenerative heating element received in the housing and adapted to transfer heat from the flue gas stream to the air stream, a plurality of flow control valves upstream of the regenerative heating element and a controller adapted to selectively open and close each valve of the plurality of flow control valves in order to provide an air flow shadow extending downstream over a selected portion of the regenerative heating element whereby ammonium bisulfate previously deposited on the selected portion is decomposed to loose dry ash. A method of decomposing and removing ammonium bisulfate from a regenerative heating element is also presented.

### RELATED APPLICATION

This application claims priority to U.S. Provisional Patent Application Ser. No. 62/896,621 filed on Sep. 6, 2019 which is hereby incorporated by reference in its entirety.

### GOVERNMENT SUPPORT

This invention was made with government support under Grant No. DE FE0031757 awarded by the U.S. Department of Energy NETL. The government has certain rights in the invention.

### TECHNICAL FIELD

This document relates generally to the field of solid fuel-fired power plants and, more particularly to a new and improved air preheater for a solid fuel-fired power plant as well as to a method for removing ammonium bisulfate from a regenerative heating element of that air preheater.

### BACKGROUND

With the deployment of intermittent electricity from wind and solar sources and the installation of smart meters, the electric grid, as a whole, has been used as an energy surge tank with the balance provided by fossil fuel-based power generation consisting of natural gas and coal-based units. Unfortunately, solid fuel-fired power plants often run into operating challenges at low load that can lead to forced outages due to the formation of ammonium bisulfate (ABS) inside the air-preheater at lower temperatures when selective catalytic reduction (SCR) for nitrogen oxides (NOₓ) is in service.

Typically, at full load, air preheaters are operated at minimum metal temperatures above 320° F., higher than the sulfuric acid dew point (approximately 250° F. for coal-derived flue gas), to avoid cold-end layer corrosion due to sulfuric acid condensation onto the metal surface. With the installation of SCR to meet EPA regulations on NOx emissions, 2-5 ppm ammonia normally pass the SCR unit unreacted. This ammonia combines with the sulfuric acid to produce ammonium bisulfate (NH₄HSO₄, ABS) at temperatures below 500° F. At partial load, particularly during deep cycling with loads below 50% of full load, the SCR is operated at a lower temperature than it is designed for and the catalyst has a reduced reactivity. To maintain 90% NOₓ reduction a relatively high NH₃/NO ratio (>0.9) is typically used to counter-balance the catalyst deactivation. Unfortunately, the high NH₃/NO ratio will result in more ammonia slip from the SCR. As the flue gas is cooled down in the air preheater to the temperature range between 300-400° F., ABS condenses as a sticky liquid on air preheater metal surfaces. Subsequently fly ash in the flue gas adheres to the heating metal surface elements, leading to serious fouling and plugging problems often resulting in significant impact to the air preheater unit's efficiency and reliability.

More specifically, four detrimental consequences have been observed:

1. instability of coal combustion and boiler operation due to high fluctuation of boiler pressure resulting from non-uniform blockage and slow blower response against a downstream pressure fluctuation;

2. approximately 20% capacity reduction from full load resulting from a limited air flow rate for given primary draft fan due to air preheater back pressure;

4. an estimated 2-3% boiler efficiency drop resulting from the high temperature of the flue gas exiting the air preheater and high air leakage between air and flue gas chambers due to high differential pressure; and

4. frequent forced outages being required for off-line cleaning.

In the past, sootblowing devices, powered by superheated steam or compressed air, have been installed at the junction of the air preheater and the flue gas duct to eliminate the fouling. However, higher concentrations of NH₃ and SO₃, occurring mostly at low load conditions, will result in higher ABS formation temperatures. A high ABS formation temperature means that the ABS will form far away from the cold end plates, into the hotter parts of the preheater, which is very difficult to clean by sootblowing. Thus, the air preheater must be taken off-line for cleaning, by forced outage, to conduct a thorough water wash.

### SUMMARY

In accordance with the purposes and benefits described herein, a new and improved air preheater and method are provided for decomposing and removing ammonium bisulfate from the regenerative heating element of an air preheater in an efficient and cost effective manner.

The air preheater for a solid fuel-fired power plant comprises: (1) a housing having (a) a flue gas inlet and a flue gas outlet adapted for directing a flue gas stream through the housing and (b) an air inlet and an air outlet adapted for directing an air stream through the housing, (2) a regenerative heating element received in the housing and adapted to transfer heat from the flue gas stream to the air stream, (3) a plurality of flow control valves in the air stream upstream of the regenerative heating element and (4) a controller adapted to selectively open and close each valve of the plurality of flow control valves in order to provide an air flow shadow extending downstream over a selected portion of the regenerative heating element whereby any ammonium bisulfate previously deposited on the selected portion is decomposed to loose dry ash.

In one or more of the many possible embodiments of the air preheater, the controller is configured to (a) maintain all of the plurality of air flow control valves in an open state in response to a first load state of the solid fuel-fired power plant and (b) close a first number of valves of the plurality of air flow control valves in response to the second load state of the solid fuel-fired power plant.

In one or more of the many possible embodiments of the air preheater, the controller is further configured to close a second number of the plurality of air flow control valves in response to the third load state of the solid fuel-fired power plant wherein the second number is greater than the first number.

The first load state may be between 70-100% of full load. The second load state may be between 50-70% of full load. The third load state may be between 25-50% of full load.

In one or more of the many possible embodiments of the air preheater, the controller is adapted to periodically open any closed valves and close at least one different valve of the plurality of air flow valves to extend a new air flow shadow downstream over a different selected portion of the regenerative heating element whereby the ammonium bisulfate previously deposited on the different selected portion of regenerative heating element is decomposed to loose dry ash.

In one or more of the many possible embodiments of the air preheater, each of the valves of the plurality of flow control valves include louvers controlled by actuators connected to and controlled by the controller.

In one or more of the many possible embodiments of the air preheater, the air preheater may also include an air blower adapted for blowing the air stream through the housing. The air blower may be controlled by the power plant operator for desired electricity output.

In one or more of the many possible embodiments of the air preheater, the air preheater may also include a plurality of temperature sensors provided downstream from the regenerative heating element in the flue gas stream and adapted to measure temperature of the flue gas stream downstream from the selected portion of the regenerative heating element after the selected portion of the regenerative heating element has been rotated into the flue gas stream.

In accordance with yet another aspect, a method is provided for decomposing and removing ammonium bisulfate from a regenerative heating element of an air preheater for a solid fuel-fired power plant. That method comprises the steps of: (a) restricting air flow over a selected portion of the regenerative heating element whereby ammonium bisulfate previously deposited on the selected portion is decomposed to loose, dry ash while simultaneously maintaining air flow over a remainder of the regenerative heating element to support operation of the solid fuel-fired power plant and (b) subsequently directing flue gas over the selected portion to sweep the loose, dry ash from the selected portion of the regenerative heating element.

The method may also include the steps of periodically restricting air flow over a different selected portion of the regenerative heating element whereby ammonium bisulfate previously deposited on the different selected portion is decomposed to the loose, dry ash while maintaining air flow over a different remainder of the regenerative heating element to support operation of the solid fuel-fired power plant and subsequently directing flue gas over the different selected portion to sweep the loose, dry ash from the different selected portion of the regenerative heating element.

Still further, the method may include the step of monitoring a flue gas temperature downstream from the selected portion after the selected portion has been rotated into the flue gas stream.

Still further, the method may include the step of monitoring the flue gas temperature downstream from the different selected portion after the different selected portion has been rotated into the flue gas stream.

The method may include the step of maintaining air flow over all of the regenerative heating element when the solid fuel-fired power plant is operating at the first percentage of full load.

In one or more of the many possible embodiments of the method, the method may include the step of closing a first number of air flow valves to restrict air flow over the selected portion of the regenerative heating element when the solid fuel-fired power plant is operating at a second percentage of full load wherein the second percentage is lower than the first percentage.

In one or more of the many possible embodiments of the method, the method may include the step of closing a second number of air flow valves to restrict air flow over the selected portion of the regenerative heating element when the solid fuel-fired power plant is operating at the third percentage of full load, wherein the second number of air flow valves is greater than the first number of air flow valves and the third percentage is lower than the second percentage.

In accordance with yet another aspect, a method of decomposing and removing ammonium bisulfate from a regenerative heating element of an air preheater for a solid fuel-fired power plant comprises the steps of: selectively closing individual valves of a plurality of air flow control valves in order to provide an air flow shadow extending downstream over a selected portion of the regenerative heating element whereby ammonium bisulfate previously deposited on the selected portion is decomposed by retained heat to loose fly ash and subsequently cleaning the loose fly ash from the selected portion of the regenerative heating element by passing flue gas over the regenerative heating element.

Further, that method may include the step of periodically opening any closed valves and closing at least one different valve of the plurality of air flow valves to extend a new air flow shadow downstream over a different selected portion of the regenerative heating element whereby the ammonium bisulfate previously deposited on the different selected portion of the regenerative heating element is decomposed to loose dry ash.

In the following description, there are shown and described several embodiments of the air preheater and related method. As it should be realized, the air preheater and method are capable of other, different embodiments and their several details are capable of modification in various, obvious aspects all without departing from the air preheater and method as set forth and described in the claims. Accordingly, the drawings and descriptions should be regarded as illustrative rather than restrictive.

### BRIEF DESCRIPTION OF THE DRAWING FIGURES

The accompanying drawing figures incorporated herein and forming a part of the specification, illustrate several aspects of the air preheater and related method and together with the description serve to explain certain principles thereof.

FIG. 1 is a schematic block diagram of the new and improved air preheater.

FIG. 2A-2D schematically illustrate how the air flow control valves of the air preheater may be periodically opened and closed to decompose ABS to loose dry ash when the solid fuel-fired power plant is being operated in the second load state.

FIG. 3A-3D schematically illustrate how the air flow control valves of the air preheater may be periodically opened and closed to decompose ABS to loose dry ash when the solid fuel-fired power plant is being operated in the third load state.

Reference will now be made in detail to the present preferred embodiments of the apparatus, examples of which are illustrated in the accompanying drawing figures.

### DETAILED DESCRIPTION

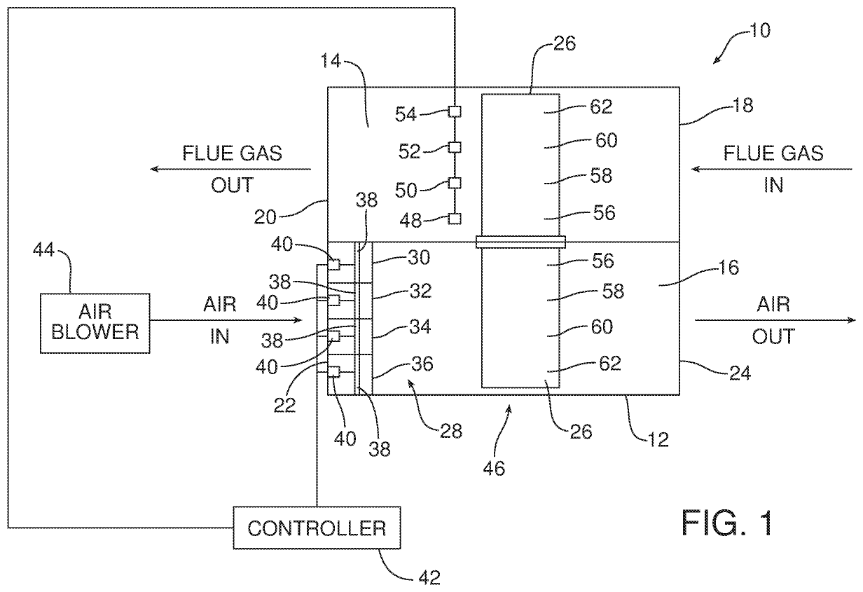

Reference is now made to FIG. 1 which schematically illustrates the new and improved air preheater 10 for a coal fired power plant. The air preheater 10 provides a number of benefits and advantages including, but not necessarily limited to, (a) a stable minimum load as low as 25-30% of full load, (b) 2-3% boiler efficiency improvement due to low air leaks, low gas pressure drop across the preheater and reduced or even eliminated use of in-line gas heater and (c) De-NOₓ efficiency improvements with relatively high ammonia injection flowrates without concern of air preheater blockage resulting from ABS formation due to high ammonia slip. The air preheater 10 is both self-cleaning and ash fouling free to increase the capacity of the solid fuel-fired power plant for load following. This allows the use of alternative energy sources (e.g. biomass such as switch grass, wood briquettes, wheat straw, corn cob or stalk, wood scraps or algae).

As illustrated in FIG. 1, the air preheater 10 is of rotary design and includes a housing 12 having a flue gas sector 14 through which flue gas flows and an air sector 16 through which air flows. More specifically, the flue gas sector 14 includes a flue gas inlet 18 and a flue gas outlet 20 adapted for directing flue gas through the housing 12. The air sector 16 includes an air inlet 22 and an air outlet 24 adapted for directing an air stream through the housing 12. The flue gas and the air flow through the air preheater 10 in counter current fashion.

A regenerative heating element 26, of a type known in the art, is received in the housing 12 and adapted to transfer heat from the flue gas stream passing through the housing in the flue gas sector 14 to the air stream passing through the housing in the air sector 16. As is known in the art, the regenerative heating element 26 is rotated through the sectors 14,16 about an axis extending along the plane of the FIG. 1 illustration. Seals (not shown) around the regenerative heating element 26 prevent leakage of flue gas and air between the sectors 14, 16.

An air blower 44 is adapted for blowing air through the housing 12 and, more particularly, the air sector of the housing by way of the air inlet 22 and the air outlet 24. A plurality of flow control valves, generally designated by reference numeral 28, are provided upstream of the regenerative heating element 26 near the air inlet 22 in the air sector 16. In the illustrated embodiment four individual flow control valves 30, 32, 34 and 36 are shown. Each valve 30, 32, 34 and 36 includes louvers 38 that are selectively opened and closed by a dedicated actuator 40.

The actuators 40 of the flow control valves 30, 32, 34 and 36 are all connected to a controller 42. Controller 42 may comprise a computing device, such as a dedicated microprocessor or an electronic control unit operating in accordance with instructions from appropriate control software. The controller 42 may include one or more processors, one of more memories and one or more network interfaces all in communication with each other over one of more communication buses.

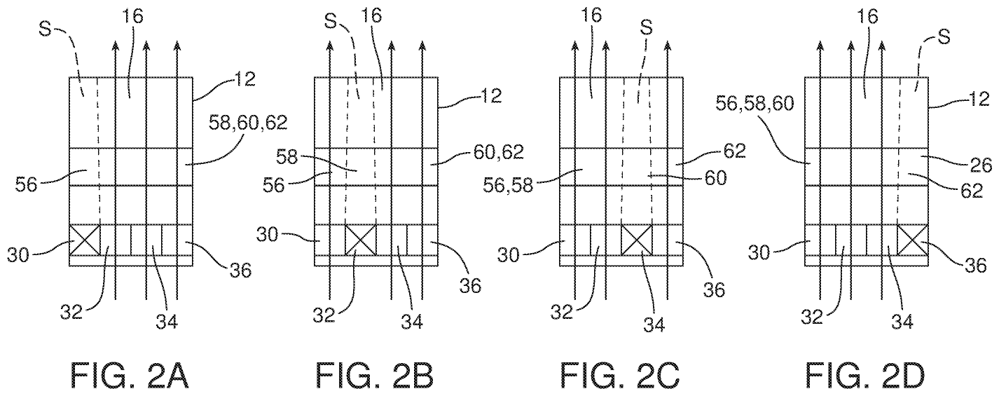

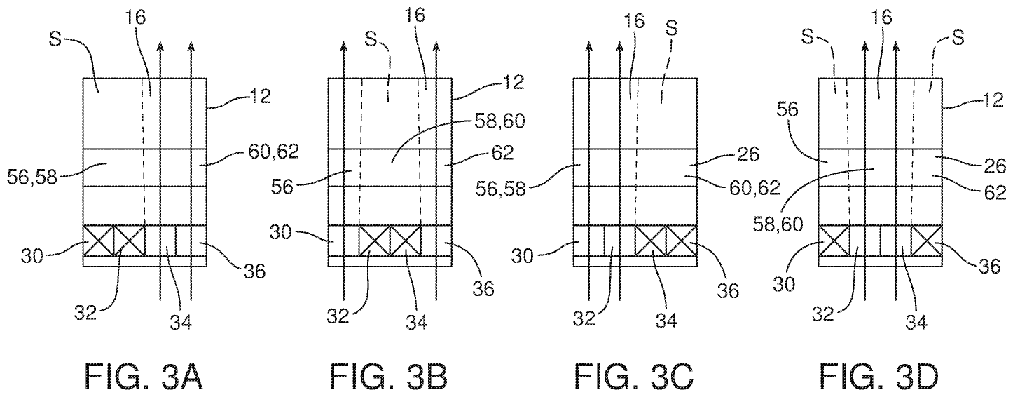

As shown in FIGS. 2A-2D and 3A-3D and described in detail below, the controller 42 is adapted or configured to selectively open and close each valve 30, 32, 34 and 36 of the plurality of flow control valves 28 in order to provide an air flow shadow S extending downstream over a selected portion of the regenerative heating element 26 whereby ammonium bisulfate previously deposited on the selected portion is decomposed to loose dry ash.

As further illustrated in FIG. 1, the controller 42 is connected to a plurality of temperature sensors generally designated by reference number 46. More specifically, four temperature sensors 48, 50, 52 and 54 are illustrated in FIG. 1.

The plurality of temperature sensors 46 are provided downstream from the regenerative heating element 26 in the flue gas sector 14. More specifically, the first temperature sensor 48 is provided downstream from and is adapted to monitor the temperature of a first selected portion 56 of the regenerative heating element 26 then rotated into the flue gas sector 14. The second temperature sensor 50 is provided downstream from and is adapted to monitor the temperature of a second selected portion 58 of the regenerative heating element 26 then rotated into the flue gas sector 14.

The third temperature sensor 52 is provided downstream from and is adapted to monitor the temperature of a third selected portion 60 of the regenerative heating element 26 then rotated into the flue gas sector 14. The fourth temperature sensor 54 is provided downstream from and is adapted to monitor the temperature of a fourth selected portion 62 of the regenerative heating element 26 then rotated into the flue gas sector 14.

The controller 42 is adapted or configured to maintain all of the plurality of air flow control valves 28 in an open state in response to a first load state of the solid fuel-fired power plant. In one possible embodiment of the air preheater 10, the first load state corresponds to between 70-100% of full load for the solid fuel-fired power plant. Under these load conditions the formation of ABS and the fouling resulting therefrom are not a concern as the temperature in the air preheater remains sufficiently high to prevent these problems from occurring.

As illustrated in FIGS. 2A-2D, the controller 42 is also configured or adapted to close a first number of valves 30, 32, 34 and/or 36 of the plurality of air flow control valves 28 in response to the second load state of the solid fuel-fired power plant. In one possible embodiment of the air preheater 10, the second load state corresponds to between 50-70% of full load for the solid fuel-fired power plant. Under these load conditions the formation of ABS and the fouling resulting therefrom is a concern as the temperature in the air preheater 10 may not remain sufficiently high to prevent these problems from occurring.

By closing at least one valve 30, 32, 34 or 36 of the plurality of flow control valves 28, an air flow shadow S extends downstream from the closed valve over a corresponding selected portion 56, 58, 60 or 62 of the regenerative heating element 26. This action functions to restrict the flow of cooling air over that selected portion whereby the selected portion is maintained at a higher temperature required to decompose any ABS previously deposited on the selected portion to loose, dry ash. That loose, dry ash is subsequently scrubbed away and cleaned from the selected portion of the regenerative heating element by the flow of the hot flue gas when that selected portion of the regenerative heating element is rotated back into the flue gas stream in the flue gas sector 14. This cleaning action is monitored and confirmed by the temperature sensor 48, 50, 52 and/or 54 located downstream from the selected portion after the selected portion is rotated back into the flue gas stream.

Reference is now made to FIGS. 2A-2D which illustrate how different flow control valves 30, 32, 34 and 36 may be periodically closed to periodically restrict air flow over different selected portions 56, 58, 60 and 62 of the regenerative heating element 26 thereby allowing the entire regenerative heating element to be kept free of ABS caused fouling.

As illustrated in FIG. 2A, the first valve 30 is closed to air flow while the second, third and fourth valves 32, 34 and 36 remain open allowing air flow (note action arrows). As a result, an air shadow S extends over a first selected portion 56 of the regenerative heating element 26 (note the area downstream from the first valve 30 identified between the dashed line and the left wall of the housing 12). Since this first selected portion 56 is out of the air stream, it is maintained at a sufficiently high temperature to both prevent the formation of ABS as well as decompose any ABS that may have been previously deposited on the first selected portion to a loose, dry ash that may be cleaned from the first portion when the first portion is again rotated into the flue gas sector 14. The remaining portions 58, 60 and 62 not in the air shadow S continue to function to transfer heat from the flue gas to the air through the regenerative heating element 26. The plurality of temperature sensors 46 continuously monitor the temperatures of the flue gas stream downstream from the selected portions 56, 58, 60 and 62 of the regenerative heating element 26 to ensure proper operation and efficient self-cleaning performance.

Once the temperature data for the first selected portion 56 of the regenerative heating element 26 provided to the controller 42 by the first temperature sensor 48 confirms that any ABS present has been decomposed to loose, dry ash, or at a preselected time, the controller 42 opens the previously closed first valve 30 and closes the second valve 32 (see FIG. 2B). As a result, air flows through the valves 30, 34 and 36 (see action arrows) over the first, third and fourth portions 56, 60 and 62 of the regenerative heating element while an air shadow S extends over a second selected portion 58 of the regenerative heating element 26 (note the area downstream of the second valve indicated between the dashed lines).

Since this second selected portion 58 is out of the air stream, it is maintained at a sufficiently high temperature to both prevent the formation of ABS as well as decompose any ABS that may have been previously deposited on the second selected portion to a loose, dry ash that may be cleaned from the second portion when the second portion is again rotated into the flue gas sector 14. The remaining portions 56, 60 and 62 not in the air shadow S continue to function to transfer heat from the flue gas to the air through the regenerative heating element 26. Again, the plurality of temperature sensors 46 continuously monitor the temperatures of the flue gas stream downstream from the selected portions 56, 58, 60 and 62 of the regenerative heating element 26 to ensure proper operation and efficient self-cleaning performance.

Once the temperature data for the second selected portion 58 of the regenerative heating element 26 provided to the controller 42 by the second temperature sensor 50 confirms that any ABS present has been decomposed to loose, dry ash, or at a preselected time, the controller 42 opens the previously closed second valve 32 and closes the third valve 34 (see FIG. 2C). As a result, air flows through the valves 30, 32 and 36 (see action arrows) over the first, second and fourth portions 56, 58 and 62 of the regenerative heating element while an air shadow S extends over a third selected portion 60 of the regenerative heating element 26 (note the area downstream of the third valve indicated between the dashed lines).

Since this third selected portion 60 is out of the air stream, it is maintained at a sufficiently high temperature to both prevent the formation of ABS as well as decompose any ABS that may have been previously deposited on the third selected portion to a loose, dry ash that may be cleaned from the third portion when the third portion is again rotated into the flue gas sector 14. The remaining portions 56, 58 and 62 not in the air shadow S continue to function to transfer heat from the flue gas to the air through the regenerative heating element 26. Again, the plurality of temperature sensors 46 continuously monitor the temperatures of the flue gas stream downstream from the selected portions 56, 58, 60 and 62 of the regenerative heating element 26 to ensure proper operation and efficient self-cleaning performance.

Once the temperature data for the third selected portion 60 of the regenerative heating element 26 provided to the controller 42 by the third temperature sensor 52 confirms that any ABS present has been decomposed to loose, dry ash, or at a preselected time, the controller 42 opens the previously closed third valve 34 and closes the fourth valve 36 (see FIG. 2D). As a result, air flows through the valves 30, 32 and 34 (see action arrows) over the first, second and third portions 56, 58 and 60 of the regenerative heating element while an air shadow S extends over a fourth selected portion 62 of the regenerative heating element 26 (note the area downstream of the fourth valve indicated between the dashed line and the right side wall of the housing 12).

Since this fourth selected portion 62 is out of the air stream, it is maintained at a sufficiently high temperature to both prevent the formation of ABS as well as decompose any ABS that may have been previously deposited on the second selected portion to a loose, dry ash that may be cleaned from the second portion when the second portion is again rotated into the flue gas sector 14. The remaining portions 56, 58 and 60 not in the air shadow S continue to function to transfer heat from the flue gas to the air through the regenerative heating element 26. Again, the plurality of temperature sensors 46 continuously monitor the temperatures of the flue gas stream downstream from the selected portions 56, 58, 60 and 62 of the regenerative heating element 26 to ensure proper operation and efficient self-cleaning performance.

This periodic opening and closing of the valves 28 and resulting restricting of air flow over the different selected portions 56, 58, 60, 62 of the regenerative heating element 26 continues for as long as the solid fuel-fired power plant is operated at the second load state.

If the solid fuel-fired power plant begins operating again in the first load state, all valves 28 are once again opened as previously described. In contrast, if the solid fuel-fired power plant begins operating in the third load state (e.g. 25-50% of full load), two of the plurality of flow control valves 28 are closed at any one time while two valves are also maintained open to direct air through the air sector 16. This is schematically illustrated in FIGS. 3A-3D. Operation otherwise continues as described above.

Thus, as illustrated in FIG. 3A the first and second valves 30, 32 are closed to create a larger air shadow S over the first and second portions 56, 58 of the regenerative heating element 26 (note area between dashed line and the left sidewall of the housing 12) whereby ABS is decomposed to loose, dry ash while the third and fourth portions 60,62 continue to function in the air flow to transfer heat to the air.

At the appropriate time, the first valve 30 is opened and the third valve 34 is closed. See FIG. 3B. As a result, an air shadow S is created over the second and third portions 58, 60 of the regenerative heating element 26 (note area between dashed line) whereby ABS is decomposed to loose, dry ash while the first and fourth portions 56, 62 continue to function in the air flow to transfer heat to the air.

Next, the second valve 32 is opened and the fourth valve 36 is closed. See FIG. 3C. As a result, an air shadow S is created over the third and fourth portions 60, 62 of the regenerative heating element 26 (note area between dashed line and the right side wall of the housing 12) whereby ABS is decomposed to loose, dry ash while the first and second portions 56, 58 continue to function in the air flow to transfer heat to the air.

Next, as illustrated in FIG. 3D, the third valve 34 is opened and the first valve 30 is closed. As a result, an air shadow S is created over the first and fourth portions 56, 62 of the regenerative heating element 26 (note area between dashed lines and the two side walls) whereby ABS is decomposed to loose, dry ash while the second and third portions 58, 60 continue to function in the air flow to transfer heat to the air.

This periodic opening and closing of the two valves of the plurality of valves 28 and resulting restricting of air flow over the different selected portions 56, 58, 60, 62 of the regenerative heating element 26 continues for as long as the solid fuel-fired power plant is operated in the third load state. When the solid fuel-fired plant begins operating in the second load state, the controller 42 switches to selectively and periodically opening one valve as illustrated in FIGS. 2A-2D. Once the solid fuel-fired power plant begins operating in the first load state, all valves 28 are once again opened.

FIGS. 2A-2D and 3A-3D illustrate and the above description describes a new and improved method of decomposing and removing ammonium bisulfate from a regenerative heating element 26 of an air preheater 10 for a solid fuel-fired power plant. That method includes the steps of: (a) restricting air flow over a selected portion 56, 58, 60 or 62 of the regenerative heating element 26 whereby ammonium bisulfate previously deposited on the selected portion is decomposed to loose, dry ash while simultaneously maintaining air flow over a remainder of the regenerative heating element to support operation of the solid fuel-fired power plant and (b) subsequently directing flue gas over the selected portion to sweep the loose, dry ash from the selected portion of the regenerative heating element.

Further, the method includes the steps of: (c) periodically restricting air flow over a different selected portion 56, 58, 60 or 62 of the regenerative heating element 26 whereby ammonium bisulfate previously deposited on the different selected portion is decomposed to the loose, dry ash while maintaining air flow over a different remainder of the regenerative heating element to support operation of the solid fuel-fired power plant and (d) subsequently directing flue gas over the different selected portion to sweep the loose, dry ash from the different selected portion of the regenerative heating element.

As noted above, the method may also include the step of monitoring a temperature of the flue gas stream downstream from the selected portion 56, 58, 60, 62 by means of one or more of the plurality of temperature sensors 46 after the selected portion has been rotated into the flue gas stream. This may include monitoring the temperature of the flue gas stream downstream from the different selected portion after the different selected portion has been rotated into the flue gas stream. This is done to ensure that the temperature of the various selected portions 56, 58, 60 and/or 62 of the regenerative heating element 26 reach a sufficiently high temperature to decompose any ABS present before altering the open/close status of any of the valves 30, 32, 34 and 36.

Still further, the method includes the steps of: (a) maintaining air flow over all of the regenerative heating element when the solid fuel-fired power plant is operating at the first percentage of full load, (b) closing a first number of air flow valves to restrict air flow over the selected portion of the regenerative heating element when the solid fuel-fired power plant is operating at the second percentage of full load wherein the second percentage is lower than the first percentage as illustrated in FIGS. 2A-2D and (c) closing a second number of air flow valves to restrict air flow over the selected portion of the regenerative heating element when the solid fuel-fired power plant is operating at the third percentage of full load, wherein the second number of air flow valves is greater than the first number of air flow valves and the third percentage is lower than the second percentage as illustrated in FIGS. 3A-3D.

Consistent with the above description, a method of decomposing and removing ABS from a regenerative heating element 26 includes the steps of: (a) selectively closing individual valves 30, 32, 34 and/or 36 of a plurality of air flow control valves 28 in order to provide an air flow shadow S extending downstream over a selected portion 56, 58, 60 and/or 62 of the regenerative heating element 26 whereby ammonium bisulfate previously deposited on the selected portion is decomposed by retained heat to loose fly ash and (b) subsequently cleaning the loose fly ash from the selected portion of the regenerative heating element by passing flue gas over the regenerative heating element.

Such a method may also include the step of periodically opening any closed valves and closing at least one different valve of the plurality of air flow valves to extend a new air flow shadow downstream over a different selected portion of the regenerative heating element whereby the ammonium bisulfate previously deposited on the different selected portion of regenerative heating element is decomposed to loose dry ash.

The foregoing has been presented for purposes of illustration and description. It is not intended to be exhaustive or to limit the embodiments to the precise form disclosed. Obvious modifications and variations are possible in light of the above teachings. For example, while the air preheater 10 illustrated in FIG. 1 is of rotary design, other designs are possible. All such modifications and variations are within the scope of the appended claims when interpreted in accordance with the breadth to which they are fairly, legally and equitably entitled.

What is claimed:

1. An air preheater for a solid fuel-fired power plant, comprising:
a housing having (a) a flue gas inlet and a flue gas outlet adapted for directing a flue gas stream through the housing and (b) an air inlet and an air outlet adapted for directing an air stream through the housing;
a regenerative heating element received in the housing and adapted to transfer heat from the flue gas stream to the air stream;
a plurality of flow control valves in the air stream upstream of the regenerative heating element; and
a controller adapted to selectively open and close each valve of the plurality of flow control valves in order to provide an air flow shadow extending downstream over a selected portion of the regenerative heating element whereby any ammonium bisulfate previously deposited on the selected portion is decomposed to loose dry ash.

2. The air preheater of claim 1, wherein the controller is configured to (a) maintain all of the plurality of air flow control valves in an open state in response to a first load state of the solid fuel-fired power plant and (b) close a first number of valves of the plurality of air flow control valves in response to the second load state of the solid fuel-fired power plant.

3. The air preheater of claim 2, wherein the controller is further configured to close a second number of the plurality of air flow control valves in response to the third load state of the solid fuel-fired power plant wherein the second number is greater than the first number.

4. The air preheater of claim 3, wherein the first load state is between 70-100% of full load.

5. The air preheater of claim 4, wherein the second load state is between 50-70% of full load.

6. The air preheater of claim 5, wherein the third load state is between 25-50% of full load.

7. The air preheater of claim 6, wherein the controller is adapted to periodically open any closed valves and close at least one different valve of the plurality of air flow valves to extend a new air flow shadow downstream over a different selected portion of the regenerative heating element whereby the ammonium bisulfate previously deposited on the different selected portion of regenerative heating element is decomposed to loose dry ash.

8. The air preheater of claim 1, wherein the controller is adapted to periodically open any closed valves and close at least one different valve of the plurality of air flow valves to extend a new air flow shadow downstream over a different selected portion of the regenerative heating element whereby the ammonium bisulfate previously deposited on the different selected portion of regenerative heating element is decomposed to loose dry ash.

9. The air preheater of claim 1, wherein each of the valves of the plurality of flow control valves include louvers controlled by actuators connected to and controlled by the controller.

10. The air preheater of claim 1, further including an air blower adapted for blowing the air stream through the housing.

11. The air preheater of claim 1, further including a plurality of temperature sensors provided downstream from the regenerative heating element in the flue gas stream and adapted to measure temperature of the flue gas stream downstream from the selected portion of the regenerative heating element after the selected portion of the regenerative heating element has been rotated into the flue gas stream.

12. A method of decomposing and removing ammonium bisulfate from a regenerative heating element of an air preheater for a solid fuel-fired power plant, comprising:
restricting air flow over a selected portion of the regenerative heating element whereby ammonium bisulfate previously deposited on the selected portion is decomposed to loose, dry ash while simultaneously maintaining air flow over a remainder of the regenerative heating element to support operation of the solid fuel-fired power plant; and
subsequently directing flue gas over the selected portion to sweep the loose, dry ash from the selected portion of the regenerative heating element.

13. The method of claim 12, including;
periodically restricting air flow over a different selected portion of the regenerative heating element whereby ammonium bisulfate previously deposited on the different selected portion is decomposed to the loose, dry ash while maintaining air flow over a different remainder of the regenerative heating element to support operation of the solid fuel-fired power plant; and
subsequently directing flue gas over the different selected portion to sweep the loose, dry ash from the different selected portion of the regenerative heating element.

14. The method of claim 13, further including monitoring a flue gas temperature downstream from the selected portion after the selected portion has been rotated.

15. The method of claim 13, further including monitoring the flue gas temperature downstream from the different selected portion after the different selected portion has been rotated into the flue gas stream.

16. The method of claim 15, further including maintaining air flow over all of the regenerative heating element when the solid fuel-fired power plant is operating at first percentage of full load.

17. The method of claim 16, further including closing a first number of air flow valves to restrict air flow over the selected portion of the regenerative heating element when the solid fuel-fired power plant is operating at the second percentage of full load wherein the second percentage is lower than the first percentage.

18. The method of claim 17, further including closing a second number of air flow valves to restrict air flow over the selected portion of the regenerative heating element when the solid fuel-fired power plant is operating at the third percentage of full load, wherein the second number of air flow valves is greater than the first number of air flow valves and the third percentage is lower than the second percentage.

19. A method of decomposing and removing ammonium bisulfate from a regenerative heating element of an air preheater for a solid fuel-fired power plant, comprising:
selectively closing individual valves of a plurality of air flow control valves in order to provide an air flow shadow extending downstream over a selected portion of the regenerative heating element whereby ammonium bisulfate previously deposited on the selected portion is decomposed by retained heat to loose fly ash; and
subsequently cleaning the loose fly ash from the selected portion of the regenerative heating element by passing flue gas over the regenerative heating element.

20. The method of claim 19, including periodically opening any closed valves and closing at least one different valve of the plurality of air flow valves to extend a new air flow shadow downstream over a different selected portion of the regenerative heating element whereby the ammonium bisulfate previously deposited on the different selected portion of regenerative heating element is decomposed to loose dry ash.
